(19) United States
(12) Patent Application Publication
(10) Pub. No.: US 2025/0019493 A1
(43) Pub. Date: Jan. 16, 2025

(54) PROCESS FOR THE PRODUCTION OF POLYESTER COPOLYMERS

(71) Applicant: Avantium Knowledge Centre B.V., Amsterdam (NL)

(72) Inventors: Bing WANG, Amsterdam (NL); Gerardus Johannes Maria GRUTER, Amsterdam (NL); Robert-Jan VAN PUTTEN, Amsterdam (NL); Daniel Herbert WEINLAND, Amsterdam (NL); Bruno BOTTEGA PERGHER, Amsterdam (NL)

(21) Appl. No.: 18/714,491

(22) PCT Filed: Dec. 22, 2022
(86) PCT No.: PCT/EP2022/087425

§ 371 Date: May 29, 2024

(30) Foreign Application Priority Data
Dec. 24, 2021 (EP) 21217722.4

(51) Int. Cl. C08G 63/672; C08G 63/199; C08G 63/81

(52) U.S. Cl. CPC C08G 63/672; C08G 63/199; C08G 63/81

(57) ABSTRACT

A polymerization process for the chemical production of a polyester copolymer starting from monomers and/or oligomers may include reacting a mixture of (a) one or more secondary diols, (b) a further diol and (c) one or more dicarboxylic acids and/or esters thereof, and/or one or more oligomers comprising monomer units of (a) and/or (b) and (c); in a process comprising (trans)esterification followed by polycondensation. The process may include addition of an inert solvent (d) which does not participate as a reagent in the polymerization reaction and which has a boiling point at ambient pressure of equal to or higher than 175° C., in an amount of 2.5-100 weight % with regard to the total weight of diols and dicarboxylic acids and/or esters thereof; to generate a polyester copolymer having a number average molecular weight (Mn), as measured by gel permeation chromatography, of 15000 daltons or more.

### FIELD OF THE INVENTION

The invention relates to a polymerization process for the chemical production of a polyester copolymer comprising reacting a mixture of one or more secondary diols, a further diol, and one or more dicarboxylic acids and/or esters thereof in a (trans)esterification step, followed by a polycondensation step, a novel polyester copolymer obtainable by said method, a composition comprising said novel polyester copolymer and an article comprising said polyester copolymer.

### BACKGROUND OF THE INVENTION

Polyethyleneterephthalate (PET) is an important polyester material and currently is the second largest in volume of the ‘big 5’ plastics, with a global annual production of around 80 million tons [www.textileworld.com/textile-world/features/2019/07/challenges-facing-recycled-polyester/]. The most common PET applications are fibres (textiles; 56 million tons/yr) and single-use packaging such as bottles (20 million tons/yr), engineering plastics and films. Although PET has a lot of favourable properties, an important disadvantage of the material is that is not biodegradable, whereas recycling of PET is still only done with only about 3% of all PET that is used worldwide. Therefore, research to develop new classes of polyesters has been initiated, and has already resulted in the discovery of other monomers that can be used in the production of new (co) polymers.

For instance, it was found that many monomers useful in today's fossil-based plastics can likely be synthesized from biobased feedstocks. One example of this is 2,5-furandicarboxylic acid (FDCA), which has been identified as a biobased alternative to terephthalic acid (TPA), which is used to produce PET. Poly(ethylene-2,5-furanoate) (PEF), a fully biobased polyester when prepared from biobased FDCA and biobased ethyleneglycol, shows superior thermal, barrier and mechanical properties compared to fossil-based PET.

Other interesting monomers are for example diol monomers, such as 1,4:3,6-dianhydrohexitols, which are a class of rigid diol monomers derived from D-glucose, D-mannose or D-idose. The monomers can be obtained after reduction of the respective sugar to the corresponding sugar alcohol and two subsequent dehydration reactions. Isosorbide is the most widely available 1,4:3,6-dianhydrohexitol due to it being derived from the sugar alcohol sorbitol.

Isosorbide is applied in polyesters, for example for increasing the glass transition temperature and for reducing the melting temperature compared to the parent polymer, as the bent structure of isosorbide weakens interactions between polymer chains. An example of a polymer in which isosorbide can be incorporated is the polyester poly(1,4-cyclohexanedimethylene terephthalate) (PCT), which possesses excellent mechanical properties due to its rigid structure. The main drawback of this polyester is, however, the high melting temperature of 278-318° C., which is close to the polymer's decomposition temperature. This results in difficult processing of the polyester, as thermal degradation can result in brittleness of the final material. The incorporation of isosorbide into the PCT polyester was investigated. The problem with isosorbide is that it carries two secondary alcohol functionalities, that generally react only very slowly, especially when compared to highly reactive primary alcohol functionalities, such as present in for example ethylene glycol or the above mentioned cyclohexane dimethanol. As a consequence, until now it has proven very difficult to produce high molecular weight copolymers with high isosorbide content.

It would be advantageous to provide an efficient process to chemically produce copolymers with a high content of, preferably sustainable, monomers derived from secondary diols, in particular (bi)cyclic secondary diols, and especially isosorbide, wherein (new) high molecular weight copolyesters are produced. Particularly interesting copolyesters have improved properties, such as improved mechanical, thermal, gas barrier, and/or caustic resistance and/or biodegradability properties compared to currently known polyesters. Further, it would be an advancement to have an efficient process available to produce a huge variety of polyester copolymers with tunable properties, which may be suitable for specific targeted applications.

### SUMMARY OF THE INVENTION

Accordingly, the present invention provides a polymerization process for the chemical production of a polyester copolymer starting from monomers and/or oligomers, comprising reacting a mixture of (a) one or more secondary diols, (b) a further diol and (c) one or more dicarboxylic acids and/or esters thereof, and/or one or more oligomers comprising monomer units of (a) and/or (b) and (c); in a process comprising (trans)esterification followed by polycondensation; wherein at least one secondary diol (a) is a (bi)cyclic secondary diol selected from 1,4:3,6-dianhydrohexitols and cis- and/or trans-2,2,4,4-tetramethyl-1,3-cyclobutanediol; and wherein in the process also an inert solvent (d) is added which does not participate as a reagent in the polymerization reaction and which has a boiling point at ambient pressure of equal to or higher than 175° C., up to equal to or lower than 300° C., preferably up to or lower than 260° C., in an amount of 2.5-100 weight % with regard to the total weight of diols and dicarboxylic acids and/or esters thereof, to generate a polyester copolymer having a number average molecular weight (Mn), as measured by gel permeation chromatography, of 15000 daltons or more.

Advantageously, the process allows more complete conversion of the (bi)cyclic secondary diols, and therefore less excess thereof is needed in the feed. By using limited amounts of the inert solvent (d), it is possible to produce a high molecular weight polyester copolymer that comprises significant quantities of monomer units derived from said (bi)cyclic secondary diol. The process of the invention opens possibilities for the convenient production of copolymers comprising increased amounts of monomer units derived from rigid sterically constrained (bi)cyclic secondary diols. Especially, when said secondary diol is isosorbide, surprisingly high content of the isosorbide-derived monomer may be found in the polyester (co) polymer product.

Accordingly, the process of the present invention allows for the preparation of polyester copolymers with tunable properties comprising monomer units derived from renewable materials, while obtaining high number average molecular weights of the polyester end product.

The present invention provides an advantageous process for the preparation of both existing and novel polyester copolymers. Said polyester copolymers can advantageously be used in a broad range of (industrial) applications, such as in films, fibres, injection (blow) moulded parts and bottles and packaging materials.

### DETAILED DESCRIPTION OF THE INVENTION

The present invention relates to a polymerization process for the production of a polyester copolymer. By a “polyester” herein is understood a polymer comprising a plurality of monomer units linked via ester functional groups in its main chain. An ester functional group can be formed by reacting a hydroxyl group (—OH) with a carboxyl/carboxylic acid group (—C(═O) OH). Typically, a polyester is a synthetic polymer formed by the reaction of one or more bifunctional carboxylic acids with one or more bifunctional hydroxyl compounds. By a “polyester copolymer” is herein understood a polyester wherein three or more types of monomer units are joined in the same polymer main chain.

By a “monomer unit” is herein understood a unit as included in a polyester copolymer or oligomer, which unit can be obtained after polymerization of a monomer, that is, a “monomer unit” is a constitutional unit contributed by a single monomer or monomer compound to the structure of the polymer or oligomer, herein in particular the smallest diol or di-acid repeating unit.

By a “monomer” or “monomer compound” is herein understood the smallest diol or di-acid compound used as the starting compound to be polymerized.

By an “oligomer” or “oligomer compound” is herein understood a molecular structure comprising an in total average number of monomer units of in the range from equal to or more than 2 to equal to or less than 9 monomer units, and preferably in the range from equal to or more than 3 to equal to or less than 5 monomer units. Next to diol and di-acid derived monomer units, also other monomer units may be part of the oligomer, such as hydroxycarboxylic acid derived monomer units, in particular derived from α-hydroxycarboxylic acids, such as glycolic acid, lactic acid, mandelic acid, and the like. The average molecular weight (Mn) of the oligomer may be equal to or more than 300 grams/mole up to 1750 grams/mole.

In the currently claimed process an inert solvent is added, which does not participate as a reagent in the polymerization reaction, i.e. it is unreactive. EP0488182A2 describes the addition of a limited amount of an inert solvent as an adjuvant in the production of polycarbonates. However, although this has been known for a few decades, it is still uncommon to use solvents in the production of polyesters. The use of solvents is usually avoided, as any solvent present in the reaction mixture will need to be removed from the final polyester product, often requiring tedious clean-up procedures. However, it was found that the presence of limited amounts of an inert solvent in the currently claimed process specifically allows for more of any (bi)cyclic secondary diols to be built into the resulting polyester copolymer. Therefore, less (or no) excess of the (bi)cyclic secondary diols is needed in the feed. As a result, high molecular weight polyester copolymers can be produced comprising significant quantities of monomer units derived from said secondary diols, in particular in case said diol is a rigid (bi)cyclic secondary diol.

Accordingly, it has now been found that such polyester copolymers, especially with high isosorbide content, can be produced by reacting a (bi)cyclic secondary diol (in particular isosorbide) with a dicarboxylic acid while using an inert, unreactive solvent with a high boiling point in 2.5-100 weight % with regard to the total weight of diols and dicarboxylic acids and/or esters thereof, with the result that both the molecular weight of the copolymer that is formed is higher than when the process is performed in the absence of any solvent and the content of the (bi)cyclic secondary diol in the end-product is increased by at least 1%, whereas also product characteristics, like glass transition temperature (Tg) may be improved. The Tg may for example be improved by at least 2° C., preferably by at least 3° C., and particularly by at least 4° C. (i.e. the Tg being higher than when in the process no inert solvent is used).

The process of this disclosure is preferably used for the production of polyester copolymers comprising monomer units derived from said (bi)cyclic secondary diol in 10-60 mole % (on the basis of total diol), for certain selected applications even up to 100 mole %. Such polyester copolymer preferably has a glass transition temperature of equal to or higher than 80° C., more preferably equal to or higher than 100° C., in particular up to and including 160° C., but for selected uses also up to 210° C. is possible.

In the process of the invention, at least one of the one or more secondary diols (a) is a (bi)cyclic secondary diols selected from the group comprising the 1,4:3,6-dianhydrohexitols: isosorbide (1,4:3,6-dianhydro-D-sorbitol), isoidide (1,4:3,6-dianhydro-L-iditol) and isomannide (1,4:3,6-dianhydro-D-mannitol), and from cis- and/or trans-2,2,4,4-tetramethyl-1,3-cyclobutanediol. Preferably the (bi)cyclic secondary diol is selected from 1,4:3,6-dianhydrohexitols, and more preferably from isosorbide and/or isoidide, and in particular the (bi)cyclic secondary diol is isosorbide. In particular at least 5 mole %, more preferably at least 10 mole % of the secondary diols (a), is selected from (bi)cyclic secondary diols. Especially preferred is a process wherein the total amount of the secondary diols is selected from (bi)cyclic secondary diols, particularly isosorbide.

The most significant difference among the class of 1,4:3,6-dianhydrohexitol isomers may be the orientation of the two hydroxyl groups. This difference in orientation will result in different orientations of the ester group in the polymer, allowing for several variations in spatial configuration and physical and chemical properties of the polymer. According to the process of the present invention, it is possible for the polyester copolymer to comprise only one isomer of 1,4:3,6-dianhydrohexitol-derived monomer units or to comprise a mixture of two or more isomers of 1,4:3,6-dianhydrohexitol-derived monomer units, for example a mixture of monomer units derived from isosorbide and/or isomannide and/or isoidide.

In the process of the invention, also other secondary diols may be used. Such secondary diol are selected from non-cyclic, aliphatic, diols. Preferred examples of non-cyclic aliphatic diols are vicinally substituted diols, such as 1,2-propanediol, 2,3-butanediol, 1,2-cyclopentanediol, 1,2-cyclohexanediol, and the like. 20 According to the process of the invention, at least one of the one or more secondary diol(s) (a) a from (bi)cyclic secondary diol, and in addition, a further diol (b), not being a secondary diol, is used. A large range of diols may be selected, depending on the desired properties of the produced polyester copolymer. Preferably, the further diol (b) is selected from C3-C18 aliphatic diols, in particular from linear, cyclic or branched, saturated C3 C12 aliphatic diol compounds, and preferably from 1,3-propanediol, 1,4-butanediol, 1,5 pentanediol, 1,6-hexanediol, diethyleneglycol, neopentylglycol, 1,4-cyclohexanedimethanol, and from acetals of polyols, especially acetals of C6 polyols, and particularly 2,3:4,5-di-O-methylene-galactitol, 2,4:3,5-di-O-methylene-D-mannitol, 2,4:3,5-di-O-methylene-D-glucitol, 2,3:4,5-di-O-isopropylidene-galactitol, 2,4:3,5-di-O-isopropylidene-D-mannitol and 2,4:3,5-di-O-isopropylidene-D-glucitol.

The type and amounts of the different monomer units in the copolymer may for instance impact the thermal properties and the crystallinity, but also barrier, mechanical and other properties. For example, the glass transition temperature Tg of the produced polyester copolymer may be targeted to a desired value by tuning the amount of the different monomer units.

Thus, conveniently several properties, like the Tg, of the produced polyester copolymer can be targeted to a desired value by tuning selection of the type and amount of the further diol (b) during the process, but also by tuning selection of the type and amount of the one or more dicarboxylic acids and/or any esters thereof (c). According to the process of this disclosure, polyester copolymers with a commercially interesting number average molecular weight may be obtained within commercially advantageous reaction times.

As stated above, the selection of the type and amount of the diols in the process influences the eventual Tg. When high Tg's are targeted (specifically higher than 80° C., more preferably equal to or higher than 100° C., in particular up to and including 160° C., but for selected uses also up to 210° C. is possible), in addition to the at least one (bi)cyclic secondary diol (a), the further diol (b) is preferably selected from (rigid) diols such as neopentylglycol, 1,4-cyclohexanedimethanol, 2,3:4,5-di-O-methylene-galactitol and 2,4:3,5-di-O-methylene-D-mannitol. In particular, 1,4-cyclohexanedimethanol is a preferred further diol (b), especially for improving impact strength of the polyester copolymer.

According to the presently claimed process, at least one (bi)cyclic secondary diol is used to produce a polyester copolymer comprising monomer units derived from said (bi)cyclic secondary diol in sufficient amounts to confer certain relevant properties. Especially when high Tg's are targeted, preferably the polyester copolymer generated by the process comprises monomer units derived from said (bi)cyclic secondary diol in at least 10 mole %, preferably 20-30 mole %, suitably 30-40 mole %, up to 60 mole %, and for certain selected applications even up to 100 mole %, the percentage based on the total amount of diol-derived monomer units in polyester copolymer. Preferably, the monomer units derived from a (bi)cyclic secondary diol are 1,4:3,6-dianhydrohexitol-derived monomer units.

As said, also the type and amount of the (c) one or more dicarboxylic acids or any esters thereof will have a tuning effect on the properties of the produced polyester copolymer. When more rigidity is desired, the one or more dicarboxylic acids and/or any esters thereof (c) is/are preferably selected from (hetero)aromatic dicarboxylic acids, and/or monoesters and/or diesters thereof, and in particular, the one or more dicarboxylic acid is selected from terephthalic acid, a terephthalic acid monoester, a terephthalic acid diester, a furandicarboxylic acid, a furandicarboxylic acid monoester, and a furandicarboxylic acid diester. Other suitable dicarboxylic acids and/or any esters thereof may be for example isophthalic acid and naphthalic acid, and/or ester derivatives thereof.

In a preferred embodiment of process of the invention, the total amount of diols and the total amount of the one or more dicarboxylic acid monomer(s) and/or any esters thereof are used in the process in a molar ratio of the total sum of diols to the total sum of dicarboxylic acids or any esters thereof of 1.5:1.0 to 1.0:1.0, and wherein in case a rigid polymer is targeted, preferably the only secondary diol (a) is isosorbide, the only further diol (b) is selected from ethylene glycol, 1,4-cyclohexanedimethanol and 1,3-propanediol, and the one or more dicarboxylic acids or any esters thereof (c) is terephthalic acid and/or furan dicarboxylic acid. In case a flexible polymer is targeted, preferably the only secondary diol (a) is isosorbide, a further diol (b) is selected from ethylene glycol, 1,4-cyclohexanedimethanol, 1,3-propanediol and 1,6-hexanediol, and the one or more dicarboxylic acids or any esters thereof (c) is succinic acid.

When the properties of the polyester copolymer are targeted towards a (relatively) high glass transition temperature in the range from equal to or higher than 80° C. to less than 160° C., but for selected uses also up to 210° C., preferably equal to or less than 140° C., the polyester (co) polymer can be very suitable for use in applications where a product, such as for example a film, fibre, injection moulded part or packaging material, needs to be heat-resistant, for example in the case of coffee cups, microwave applications and certain medical applications. Also, (co) polymers for ABS replacement may be targeted. On the other hand, when the polyester copolymer is targeted towards a medium glass transition temperature in the range from equal to or more than 60° C. to equal to or less than 100° C., the polyester copolymer can be very suitable for use in applications where a product needs to remain resilient at low temperatures and/or needs to be able to withstand cold without breaking or becoming too brittle, for example in the case of outdoor furniture. When the polyester copolymer is targeted towards a glass transition temperature in the range from equal to or more than 60° C. to equal to or less than 120° C. or equal to or less than 100° C., the polyester copolymer can be very suitable for the replacement of poly(ethylene terephthalate) (PET) in applications such as bottles and/or containers.

Preferably, the diols and/or dicarboxylic acids used in the current process are obtained and/or derived from a renewable source, e.g. sustainable biomass material. By a biomass material is herein understood a composition of matter obtained and/or derived from a biological source as opposed to a composition of matter obtained and/or derived from petroleum, natural gas or coal. The biomass material can for example be a polysaccharide, such as starch, or a cellulosic and/or lignocellulosic material. By sustainable is herein understood that the material is harvested and/or obtained in a manner such that the environment is not depleted or permanently damaged. Sustainable biomass material may for example be sourced from forest waste, agricultural waste, waste paper and/or sugar processing residues. Isosorbide, isomannide and isoidide can be suitably obtained by dehydrating respectively sorbitol, mannitol and iditol. The synthesis of these 1,4:3,6-dianhydrohexitols per se is well known in the art.

The amounts of each of the different monomeric units in the polyester copolymer often can be determined by proton nuclear magnetic resonance (1H NMR). One skilled in the art would easily find the conditions of analysis to determine the amount of each of the different monomer units in the polyester copolymer. Other analysis methods can include depolymerization, followed by monomer quantification (versus standards). Polyesters can be depolymerized in water (hydrolysis), in alcohol, e.g. methanol (alcoholysis, e.g. methanolysis) or in glycol (glycolysis). An excess of depolymerization solvent ensures full depolymerization and a catalyst (e.g. a base) can accelerate the depolymerization.

The polyester copolymer(s) according to the invention can be a random copolymer or can have a more blocky microstructure.

The number average molecular weight (Mn) of the polyester copolymer(s) may vary and may depend for example on the added monomer type and amount, the catalyst, the reaction time and reaction temperature and pressure. Advantageously, the number average molecular weight of the polyester copolymer(s) according to the invention is at least 15000 grams/mole and preferably the number average molecular weight is equal to or more than 16500 grams/mole, more preferably of equal to or more than 20000 grams/mole up to as high as 100000 grams/mole.

The weight average molecular weight (Mw) and the number average molecular weight (Mn) can be determined by means of gel permeation chromatography (GPC) at 35° C., using for the calculation poly(methyl methacrylate) standards as reference material, and using hexafluoro-2-propanol as eluent. All molecular weights herein are determined as described under the analytical methods section of the examples.

Suitably the polyester copolymer according to the present invention may have a polydispersity index (that is, the ratio of weight average molecular weight (Mw) to number average molecular weight (Mn), i.e. Mw/Mn) in the range from equal to or higher than 1.6 to equal to or lower than 2.8, in particular from equal to or higher than 1.8 to equal to or lower than 2.6.

The glass transition temperature of the polyester copolymer can be measured by conventional methods, in particular by using differential scanning calorimetry (DSC) with a heating rate of 10° C./minute in a nitrogen atmosphere. All glass transition temperatures herein are determined as described under the analytical methods section of the examples.

The limited amounts of the inert solvent used in the process of this disclosure may serve as a diluent in the reaction mixture, which may be desirable or considered necessary under certain circumstances. For instance, when using the inert solvent according to the presently claimed process, and when compared to polymerization techniques known in the art, less of the isosorbide is lost during polymerization, and more isosorbide is incorporated in the resulting polyester copolymer.

Preferably, the inert solvent (d) is selected from substituted benzenes wherein the substitutents are selected from halogen, alkoxy and/or alkyl, further the inert solvent (d) is selected from optionally substituted diphenylether, diphenylsulfone, and any combination thereof, wherein unsubstituted diphenylether is preferred.

Suitably, the total amount of the inert solvent (d) is as added at the start of the reaction. The addition of the solvent may take place before the reaction starts, e.g. preferably by first mixing the monomer(s) with the solvent. Also, the solvent may be added in a later stage during the reaction, or both at the start and during the reaction, whenever required. In an embodiment, some of the inert solvent (d) is added as from the start of the (trans)esterification step and, in addition, more of the inert solvent (d) is continuously supplied to the reaction mixture during the (trans)esterification step. Generally, a skilled person would look at viscosity and would try to allow water (condensation product) to be removed more easily, and based on that decide at which stage it would be best to add a bit more of the inert solvent.

As the process of the invention proceeds, the inert solvent (d) present in the reaction mixture, is/are released from the reactor. The released materials can advantageously be separated and purified to be recycled. Therefore, another embodiment of the invention relates to the above described polymerization process, comprising in addition, separating the inert solvent (d) (e.g. by distillation), optionally followed by purifying the separated materials to recover the purified inert solvent (d), and preferably recycling said purified inert solvent (d) into the process.

The process according to the invention may comprise several stages. Suitably the process according to the invention comprises an esterification/transesterification stage and a polycondensation stage, wherein the esterification/transesterification stage is carried out prior to the polycondensation stage. The esterification/transesterification stage may suitably be preceded by an introduction stage, comprising introducing the suitable monomers into a reactor. During the esterification/transesterification reaction, condensation products, such as water, may be distilled off. The polycondensation stage may suitably be succeeded by a recovery stage, wherein the polyester copolymer is recovered from a reactor.

The process according to the invention can be carried out in a batch-wise, semi-batchwise or continuous mode. The esterification/transesterification stage and the polycondensation stage may conveniently be carried out in one and the same reactor, but may also be carried out in two separate reactors, for example where the esterification/transesterification stage is carried out in a first esterification/transesterification reactor and the polycondensation stage is carried out in a second polycondensation reactor.

In any introduction stage the monomers and/or oligomers may be introduced into the reactor simultaneously, for example in the form of a feed mixture, or in separate parts. The monomers and/or oligomers may be introduced into the reactor in a molten phase or they can be molten and mixed after introduction into the reactor.

Any transesterification stage is preferably carried out in a reaction time in the range from equal to or more than 0.5 hour, more preferably equal to or more than 1.0 hour, to equal to or less than 20.0 hours, preferably to equal to or less than 10 hours, more preferably equal to or less than 6.0 hours. During a transesterification stage, the temperature may be stepwise or gradually increased.

Any polycondensation stage is preferably carried out in a reaction time in the range from equal to or more than 0.5 hour, more preferably equal to or more than 1.0 hour, to equal to or less than 8.0 hours, more preferably equal to or less than 6.0 hours. During a polycondensation stage, the temperature may be stepwise or gradually increased.

The polycondensation stage may suitably be carried out at a temperature equal to or higher or a bit lower than the temperature at which the transesterification stage is carried out depending on the polymers. The transesterification stage may for example be carried out at a temperature in the range from equal to or higher than 170° C., and depending on the desired polymer (e.g. high Tg polymers) preferably equal to or higher than 210° C., and even more preferably equal to or higher than 230° C., to equal to or lower than 260° C. The polycondensation stage may suitably succeed the transesterification stage and the polycondensation stage can for example be carried out at a temperature in the range from equal to or higher than 220° C., and depending on the desired polymer (e.g. high Tg polymers) more preferably equal to or higher than 265° C., to equal to or lower than 300° C., more preferably equal to or lower than 285° C. and most preferably equal to or lower than 275° C.

The polycondensation stage may be succeeded by a recovery stage, wherein the polyester copolymer as described above is recovered from the reactor. The polyester can for example be recovered by extracting it from the reactor in the form of a string of molten polymer. This string can be converted into granules using conventional granulation techniques.

The esterification/transesterification stage is preferably carried out under an inert gas atmosphere, suitably at ambient pressure or slightly above that, e.g. up to 5 bar. Preferably, the polycondensation stage is carried out at reduced pressure.

The (trans)esterification in the present process is performed at elevated temperatures, in particular at a temperature of 230° C. or higher, and preferably during the polycondensation the pressure is gradually reduced, while at the same time gradually removing the inert solvent (d) and optionally other volatile components.

A suitable and advantageous way to perform the process of the invention comprises the following steps: (i) in a reaction vessel heating, in the presence of a catalyst, a mixture of the diol monomer(s), the dicarboxylic acid monomer(s) and/or any esters thereof and the inert solvent to a certain temperature for a certain period of time until a clear melt is obtained; (ii) continuing the esterification/transesterification reaction (under stirring) at elevated temperature while removing condensation products (specifically water) and possibly the inert solvent (depending on its boiling point) at a pressure of 1 to 5 bar; (iii) reducing the pressure in the vessel of step (ii) to a vacuum of lower than 20 mbar, preferably lower than 10 mbar, more preferably lower than 5 mbar, and particularly lower than 1 mbar, with continued stirring for a certain period of time; and optionally during step (iii) further increasing the temperature by 10 to 50° C. —to facilitate removal of remaining condensation products and solvent from the reactor.

The process according to the invention may be carried out in the presence of one or more additives, such as stabilizers, for example light stabilizers, UV stabilizers and heat stabilizers, fluidifying agents, flame retardants, ether formation suppressants and antistatic agents. Phosphoric acid is an example of a stabilizer applied in PET. Additives may be added at the start of the process, or during or after the polymerization reaction. Other additives include primary and/or secondary antioxidants. A primary antioxidant can for example be a sterically hindered phenol, such as the compounds Hostanox® 0 3, Hostanox® 0 10, Hostanox® 0 16, Ultranox® 210, Ultranox®276, Dovernox® 10, Dovernox® 76, Dovernox® 3114, Irganox® 1010 or Irganox® 1076. A secondary antioxidant can for example be a trivalent phosphorous-comprising compounds, such as Ultranox® 626, Doverphos® S-9228 or Sandostab® P-EPQ.

The process according to the invention is suitably carried out in the presence of a catalyst, preferably a metal-containing catalyst. The catalyst preferably is used in amounts from 0.01 mole % to 0.5 mole % with regard to the total amount of monomers (in moles). Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti alkoxides. Examples of such compounds can, for example, be those given in US2011282020A1 in sections [0026] to [0029], and on page 5 of WO 2013/062408 A1. Preferably the metal-containing catalyst is a tin-containing catalyst, for example a tin(IV)- or tin(II)-containing catalyst. More preferably the metal-containing catalyst is an alkyltin(IV) salt and/or alkyltin(II) salt. Examples include alkyltin(IV) salts, alkyltin(II) salts, dialkyltin(IV) salts, dialkyltin(II) salts, trialkyltin(IV) salts, trialkyltin(II) salts or a mixture of one or more of these. These tin(IV) and/or tin(II) catalysts may be used with alternative or additional metal-containing catalysts. Examples of alternative or additional metal-containing catalysts that may be used include one or more of titanium(IV) alkoxides or titanium(IV) chelates, zirconium(IV) chelates, or zirconium(IV) salts (e.g. alkoxides); hafnium(IV) chelates or hafnium(IV) salts (e.g. alkoxides); yttrium(III) alkoxides or yttrium(III) chelates; lanthanum(III) alkoxides or lanthanum chelates; scandium(III) alkoxides or chelates; cerium (III) alkoxides or cerium chelates. An exemplary metal-containing catalyst is n-butyltinhydroxide oxide (also known as butyltin hydroxide oxide hydrate).

The process according to the invention may optionally further comprise, in case the polymer is semi-crystalline, after a recovery stage (i.e, wherein the polyester copolymer is recovered from the reactor) as described above, a stage of polymerization in the solid state. That is, the polyester copolymer recovered as described above may be polymerized further in the solid state, thereby increasing chain length. Such polymerization in the solid state is also referred to as a solid state polymerization (SSP). Such a solid state polymerization advantageously allows one to further increase the number average molecular weight of the polyester copolymer. If applicable, SSP can further advantageously enhance the mechanical and rheological properties of polyester copolymers before injection blow molding or extruding. The solid state polymerization process preferably comprises heating the polyester copolymer in the essential or complete absence of oxygen and water, for example by means of a vacuum or purging with an inert gas.

Advantageously the process according to the invention can therefore comprise:
a melt polymerization wherein the above described copolymers are polymerized in a melt to produce a polyester copolymer melt product;
an optional pelletisation wherein the polyester copolymer melt product is converted into pellets, and the optional drying of the pellets under vacuum or with the help of inert gas purging;
an optional solid state polymerization of the polyester copolymer melt product, optionally in the form of pellets, at a temperature above the Tg of the polyester copolymer melt product and below the melt temperature of the polyester copolymer melt product.

Generally, solid state polymerization may suitably be carried out at a temperature in the range from equal to or more than 150° C. to equal to or less than 220° C. The solid state polymerization may suitably be carried out at ambient pressure (i.e. 1.0 bar atmosphere corresponding to 0.1 MegaPascal) whilst purging with a flow of an inert gas (such as for example nitrogen or argon) or may be carried out at a vacuum, for example a pressure equal to or below 100 millibar (corresponding to 0.01 MegaPascal). The solid state polymerization may suitably be carried out for a period up to 120 hours, more suitably for a period in the range from equal to or more than 2 hours to equal to or less than 60 hours. The duration of the solid state polymerization may be tuned such that a desired final number average molecular weight for the polyester copolymer is reached.

Polyester copolymers obtained by or obtainable by the process of the invention can suitably be combined to form a composition with additives and/or other (co) polymers, as known in the art, such as nucleating agents, opacifying agents, dyes and pigments.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used.

The compositions can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition can suitably be carried out at a temperature ranging from 160 to 300° C., preferably under an inert atmosphere. In the case of an extruder, the various constituents of the composition can suitably be introduced using introduction hoppers located along the extruder.

The polyester copolymer obtained or obtainable by the process of the invention may conveniently be used in the manufacturing of films, fibres, injection moulded parts and packaging materials, such as for example receptacles. The use of the polyester copolymer is especially advantageous where such films, fibres, injection moulded parts or packaging materials need to be heat-resistant or cold-resistant.

The invention is further illustrated by the following non-limiting examples.

### EXAMPLES

### List of Abbreviations

DSC=differential scanning calorimetry
CHDM=1,4-cyclohexanedimethanol
FDCA=2,5-furandicarboxylic acid
GPC=gel permeation chromatography
HFIP=hexafluoro-2-propanol
IPA=isophthalic acid
ISO=isosorbide
Mn=number average molecular weight
Mw=weight average molecular weight
PDI=polydispersity index
PICT=poly(isosorbide-co-cyclohexanedimethyleneterephthalate)
PMMA=poly(methyl methacrylate)
TPA=(purified) terephthalic acid
TCE=1,1,2,2-tetrachloroethane
TCE-d2=1,2-dideutero-1,1,2,2-tetrachloroethane
Tg=glass transition temperature

### Analytical Methods:

In the below examples, the weight average molecular weight (Mw) and the number average molecular weight (Mn) have been determined by means of gel permeation chromatography (GPC). GPC measurements were performed at 35° C. For the calculation PMMA standards were used as reference material. As eluent HFIP was used at 1 mL/min. The GPC measurements were carried out under these conditions on a Hitachi Chromaster 5450 with a Agilent HPLC system equipped with two PFG 7 micrometer (μm) Linear M (300×7.5 mm) columns. Calculation of the molecular weights was carried out with Astra 6 Software.

The glass transition temperature of the polyester polymers and copolymers in the below examples was determined using differential scanning calorimetry (DSC) with heating rate 10° C./minute in a nitrogen atmosphere. In the second heating cycle, a glass transition, (Tg), was recorded.

The content of the monomer units in the polyester polymers and copolymers of the below examples was determined by proton nuclear magnetic resonance (1H NMR). The content of diol and diacid monomer units was determined using deutero-dichromethane as a solvent, and dichloromethane as a reference.

### Example 1

Preparation of poly(isosorbide-co-cyclohexanedimethyleneterephthalate) (PICT)

In a 100 ml glass reactor, all the components were added before heating: 9.97 g of terephthalic acid as basis (60.0 mmol), 4.40 g of isosorbide (30.1 mmol), 4.34 g of 1,4-cyclohexanedimethanol (30.1 mmol), an amount of an inert solvent (see details in Table 1), catalyst (butyltin hydroxide oxide hydrate, 0.14 mol % vs. TPA). In a first phase, the esterification, the reaction system was heated by an oil bath at a certain temperature under nitrogen flow at 30 mL/min for a certain period of time (see Table 1 for details). Starting the second phase, the polycondensation, the oil temperature was increased (if necessary) and the nitrogen flow was stopped, replaced by vacuum at 500 mbar. Step-wise, the vacuum was reduced and the solvent was collected in the distillation flask. As the polymer became more viscous, the temperature was increased step-wise, up to a maximum of 285° C. (see Table 1 for details). The torque registered by the mechanical stirrer increased as the polymer became more viscous, from 16 N·cm up to a maximum of 34 Ncm. The vacuum was slowly reduced, after which the system was kept below 1 mbar (down to 0.4 mbar). For comparison, the reaction was also performed in absence of a solvent.

Results are shown in Table 1.

TABLE 1

| | | | Poly- | | | | |
|---|---|---|---|---|---|---|---|
| | | Esterification | condensation | Mₙ | | | ISO^{c} in |
| inert solvent | | oil T [° C.]; | oil T [° C.]; | (GPC) | | | polymer |
| (wt %.) ^{a} | BP^{b} (° C.) | t [h] | t [min] ^{a} | [kg/mol] | PDI | T_{g} [° C.] | (mol %) |
| none | — | 260-270; 12 | 270-285; 2.8 | 13.7 | 2.4 | 135.8 | 46.5 |
| Diphenylether | 258 | 260-265; 5 | 265-285; 2.5 | 15.2 | 2.3 | 140.5 | 48.9 |
| (65) | | | | | | | |
| 1,4-dimethoxy- | 213 | 260-265; 6.7 | 265-285; 2.5 | 15.3 | 2.1 | 140.4 | 48.4 |
| benzene | | | | | | | |
| (53) | | | | | | | |

^{a} the amount of inert solvent in weight % relative to the total weight of (diol and diacid) monomers
^{b}boiling point (BP) of solvent at ambient pressure
^{c}isosorbide derived monomer content in polymer end product, determined by ¹H-NMR.

1. A polymerization process for the chemical production of a polyester copolymer starting from monomers and/or oligomers, comprising reacting a mixture of (a) one or more secondary diols, (b) a further diol and (c) one or more dicarboxylic acids and/or esters thereof, and/or one or more oligomers comprising monomer units of (a) and/or (b) and (c); in a process comprising (trans)esterification followed by polycondensation;
wherein at least one secondary diol (a) is a (bi)cyclic secondary diol selected from 1,4:3,6-dianhydrohexitols and cis- and/or trans-2,2,4,4-tetramethyl-1,3-cyclobutanediol; and
wherein in the process also an inert solvent (d) is added which does not participate as a reagent in the polymerization reaction and which has a boiling point at ambient pressure of equal to or higher than 175° C., in an amount of 2.5-100 weight % with regard to the total weight of diols and dicarboxylic acids and/or esters thereof;
to generate a polyester copolymer having a number average molecular weight (Mn), as measured by gel permeation chromatography, of 15000 daltons or more.

2. The process of claim 1, wherein the (trans)esterification is performed at a temperature of 230° C. or higher, and wherein during the polycondensation the pressure is gradually reduced, at the same time gradually removing the inert solvent (d) and optionally other volatile components.

3. The process of claim 1, wherein at least one (bi)cyclic secondary diol is isosorbide.

4. The process of claim 1, wherein the one or more dicarboxylic acid (c) is/are selected from (hetero)aromatic dicarboxylic acids, and/or monoesters and/or diesters thereof, and in particular, the one or more dicarboxylic acid is selected from terephthalic acid, a terephthalic acid monoester, a terephthalic acid diester, a furandicarboxylic acid, a furandicarboxylic acid monoester, and a furandicarboxylic acid diester.

5. The process of claim 1, wherein the further diol (b) is selected from C3-C18 aliphatic diols, in particular from linear, cyclic or branched, saturated C3-C12 aliphatic diol compounds, the hydroxyl groups preferably being at least attached to non-neighboring carbon atoms, and preferably from 1,3-propanediol, 1,4-butanediol, 1,5-pentanediol, 1,6-hexanediol, diethyleneglycol, neopentylglycol, 1,4-cyclohexanedimethanol, and from acetals of polyols, especially acetals of C6 polyols, and particularly 2,3:4,5-di-O-methylene-galactitol, 2,4:3,5-di-O-methylene-D-mannitol, 2,4:3,5-di-O-methylene-D-glucitol, 2,3:4,5-di-O-isopropylidene-galactitol, 2,4:3,5-di-O-isopropylidene-D-mannitol and 2,4:3,5-di-O-isopropylidene-D-glucitol, and especially the further diol (b) is 1,4-cyclohexanedimethanol.

6. The process of claim 1, wherein the inert solvent (d) is selected from substituted benzenes wherein the substitutents are selected from halogen, alkoxy and/or alkyl, further the inert solvent (d) is selected from optionally substituted diphenylether, diphenylsulfone, and any combination thereof, wherein unsubstituted diphenylether is preferred.

7. The process of claim 1, wherein the total amount of the inert solvent (d) is as added at the start of the reaction.

8. The process of claim 1, wherein some of the inert solvent (d) is added as from the start of the (trans)esterification step and, in addition, more of the inert solvent (d) is continuously supplied to the reaction mixture during the (trans)esterification step.
